(19) United States
(12) Patent Application Publication
(10) Pub. No.: US 2010/0068461 A1
(43) Pub. Date: Mar. 18, 2010

(54) NANOSTRUCTURED COMPOSITES

(75) Inventors: Gordon George Wallace, Gwynnville (AU); Ju Chen, Balgownie (AU); Andrew Ian Minett, New South Wales (AU); Graeme Milbourne Clark, Eltham (AU)

Correspondence Address: Ballard Spahr LLP, SUITE 1000, 999 PEACHTREE STREET, ATLANTA, GA, 30309-3915, US

(73) Assignee: UNIVERSITY OF WOLLONGONG, Wollongong, NSW (AU)

(21) Appl. No.: 12/307,017

(22) PCT Filed: Jun. 29, 2007
(86) PCT No.: PCT/AU2007/000913

§ 371 Date: Nov. 11, 2009

(30) Foreign Application Priority Data
Jun. 30, 2006 (AU) 2006903544

(51) Int. Cl. B32B 3/10; B29C 39/02

(52) U.S. Cl. 428/156; 264/299

(57) ABSTRACT

The present invention relates to nanostructured composites, in particular nanotube/substrate composites for use in the fields of biomedical materials and devices as well as energy conversion and storage, ion transport and liquid and gas separation. The use of such composites as biomaterials are of particular interest.

### FIELD

The present invention relates to nanostructured composites, in particular nanotube/substrate composites for use in the fields of biomedical materials and devices as well as energy conversion and storage, ion transport and liquid and gas separation. The use of such composites as biomaterials are of particular interest.

### BACKGROUND

Electrodes for photochemical cells or fuel cells should have high surface area to enable efficient charge transfer to the electrolyte. For photochemical cells they should also have a high interfacial area between the photoactive polymer and the point where charge separation occurs.

Electrodes to be used in devices for charge storage are also required to have a high surface area and high conductivity.

Bio-electrodes are used to deliver charge to, or sense electric pulses on or within living organisms. Common bio-electrodes include pacemaker electrodes and electrocardiogram (ECG) pads. The interaction between an electrode and a living organism is essential to its long term use. An electrode must be biocompatible, so that it is not toxic to the living organism in which it is implanted. Controlling the response of the body to an implanted electrode is also critical to its long-term use. For pacemaker electrodes, many materials are biocompatible, but the body responds by enveloping them in fibrous tissue which increases the threshold charge for stimulation. There is still much potential to improve pacemaker electrodes by increasing their surface area, and decreasing the amount of fibrous tissue that envelopes them when they are implanted.

Commercial implantable bio-electrodes for humans are made from Pt and Pt—Ir alloys. Often these metals are coated with titanium nitride or conducting oxides (eg. RuO₂ or IrO₂) to increase their surface area, or adjust their bio-interaction.

Carbon nanotubes present a new material for the construction of electrodes for electrochemical devices such as batteries, capacitors and actuators. Such electrodes require high conductivity, strength and surface area. The latter two requirements are often incompatible. Electrodes composed entirely of carbon nanotubes (bucky paper) have high surface areas but are typically weak, and have insufficient conductivity for practical macroscopic applications.

There has been much investigation into the manufacture of carbon nanotubes. For instance, carbon nanotube platforms have been manufactured via the formation of aligned CNT arrays. The large scale synthesis of vertically aligned CNTs was first reported by Li et al [1], who reported the large-scale synthesis of aligned carbon nanotubes using a method based on chemical vapor deposition catalyzed by iron nanoparticles embedded in mesoporous silica.

Techniques for manufacturing vertically aligned carbon nanotube forests and arrays fabricated on catalyst printed planar substrates by chemical vapor deposition require deposition and patterning, usually in separate processing steps, of catalyst material, typically in nanoparticle assemblies or thin film forms. This complicates the nanotube fabrication method. Some techniques require the use of a mesoporous material.

Manufacture of nanotubes with orientation parallel to a substrate has been achieved by adjusting the gas flow during chemical vapour deposition or applying an electrical field during growth. However, these approaches require pre-deposition and pre-patterning of nanoscale catalyst particle assemblies. Also, these methods are inherently complicated, are difficult to scale and to control for developing devices for particular applications. Moreover, in these cases the nanotubes are not connected to the substrate. Rather they are just lying on them, and therefore any connection to the substrate is not mechanically robust.

There is a need to develop simple methods of making nanotube composites that are mechanically robust and with sufficient conductivity for use in applications such as bioelectrodes and electrodes for energy storage and conversion.

### SUMMARY

The present invention provides a nanostructured composite comprising nanotubes partially embedded and physically retained by a substrate, forming a nanotube substrate structure. When partially embedded, the nanotubes protrude from the substrate resulting in exposed nanotube tips.

The nanotubes of the nanostructured composite are preferably aligned nanotubes.

The nanotubes are oriented in the nanostructured composite such that they protrude from the substrate. They are attached to the substrate and by attached we mean physically retained by the substrate. The nanotubes are partially embedded in the substrate, that is, a portion of the nanotube is embedded in the substrate and the remaining portion of the nanotube protrudes from the substrate. In one embodiment the nanotubes do not fully penetrate the substrate when “attached” to the substrate.

In one embodiment, the composite includes a metal and/or metal oxide layer. The metal and/or metal oxide layer may be above or below the substrate, preferably below. This results in metal and/or metal oxide layer/substrate/nanotubes, wherein the nanotubes are partially embedded in the metal and/or metal oxide layer and the substrate.

The present invention also provides a process for preparing a nanostructured composite which comprises the steps of:
i) providing a nanotube layer;
ii) integrating a substrate, optionally comprising a biomolecule, to the nanotube layer produced in step i); and
iii) forming nanotube/substrate composite structure.

The nanotube layer formed in step i) is preferably an aligned nanotube layer.

In one embodiment the substrate and nanotubes are biocompatible resulting in a biomaterial composite. The substrate and/or the nanotubes may be biocompatible.

In one embodiment the substrate comprises a conducting component resulting in a composite having electrically conducting properties.

In one embodiment the substrate of step ii) is in the form of a dispersing media, optionally comprising a biomolecule, the dispersing media being cast on to the nanotube layer. In this embodiment, the present invention provides a process for preparing a nanostructured composite which comprises the steps of:
(i) providing a nanotube layer;
(ii) providing a dispersion comprising dispersing media and substrate material, optionally comprising a biomolecule; and
(iii) integrating the dispersion onto the nanotube layer, and
(iv) forming nanotube/substrate composite structure.

In one embodiment prior to integrating the substrate to the nanotube layer a pre-integration step is provided. In this pre-integration step, one or more metal and/or metal oxide layers are deposited on to the nanotube layer. The pre-integration step involves any commonly used procedure for depositing a metal and/or metal oxide layer.

It is envisaged that the metal and/or metal oxide layer is sufficiently porous to enable the substrate material to infiltrate and hold the composite structure firmly together.

In one embodiment the substrate comprises a conducting component resulting in a composite having electrically conducting properties.

Such nanostructured nanotube composites are electrically conductive and mechanically robust. The nanotubes, preferably aligned nanotubes, are partially embedded into the substrate, forming an integrated nanotube/substrate composite structure. They can be used for applications requiring electrical conduction or sensing such as bio-electrodes for example pacemaker electrodes and ECG pads.

The composite structure of the present invention can provide an effective interface with biological tissue for the treatment and/or prevention of disease. The composite can allow the release of medicinal agents for example trophic agents and/or delivery of electrical charge for applications such as the protection and regeneration of nerve fibres and provision of patterns of electrical stimulation. Examples of outcomes are the correction of deafness, spinal cord and nerve injury, drug resistant epilepsy, and improved arterial stents.

The composite structure of the present invention can also be utilised in the area of energy storage and energy conversion.

### DETAILED DESCRIPTION

### Structure of Composite

### Nanotube:

Nanotubes are typically small cylinders made of organic or inorganic materials. Known types of nanotubes include carbon nanotubes, metal oxide nanotubes such as titanium dioxide nanotubes and peptidyl nanotubes. Preferably the nanotubes are carbon nanotubes (CNTs).

CNTs are sheets of graphite that have been rolled up into cylindrical tubes. The basic repeating unit of the graphite sheet consists of hexagonal rings of carbon atoms, with a carbon-carbon bond length of about 1.45 Å. Depending on how they are made, the nanotubes may be single-walled nanotubes (SWNTs), double walled carbon nanotubes (DWNTs) and/or or multi-walled nanotubes (MWNTs). A typical SWNT has a diameter of about 0.7 to 1.4 nm, double walled to 3 to 5 nm and multi-walled 5 to 100 nm.

The structural characteristics of nanotubes provide them with unique physical properties.

Nanotubes may have up to 100 times the mechanical strength of steel and can be up to several mm in length. They exhibit the electrical characteristics of either metals or semiconductors, depending on the degree of chirality or twist of the nanotube. Different chiral forms of nanotubes are known as armchair, zigzag and chiral nanotubes. The electronic properties of carbon nanotubes are determined in part by the diameter and length of the tube.

As described earlier the nanotubes are oriented in the nanostructured composite such that they protrude from the substrate, in other words they are partially embedded in the substrate. The protruding nanotubes are highly conducting. The protruding needle-like nanotubes can be coated to profer additional properties to the composite.

### Coating:

Suitable coatings include, but are not limited to biodegradable polymers and electronically conducting films. Metallic coatings are also envisaged. The coatings can also include additives that confer additional properties to the coating, and that, on release from the coating, can convey desirable ingredients to the immediate environment of the composite.

In the embodiment where the coating comprises an electrically conducting film, the film can be deposited on the exposed nanotube tips using electrochemical deposition. This can result in the conducting needles of nanotubes being interconnected by a conducting layer. Any electrically conducting film is envisaged for use in this manner. Suitable examples include polyethylene, polyethylene dioxythiophene (PEDOT), soluble polypyrroles, polythiophenes, polyanilenes, combinations thereof and/or nanodispersions of these materials.

In the embodiment where the coating comprises a biodegradable polymer, it is understood that any biodegradable polymer can be utilised here. One example is PLGA-PLA co-polymer. It will be appreciated that any commonly used methods of deposition can be utilised to deposit the biodegradable polymer coating to the nanotubes.

The coating may comprise a combination of electrically conducting and biodegradable polymers. The coating may comprise a polymer that is both biodegradable and electrically conductive.

As stated above, the coating can include additives which either confer properties to the coating itself, or can be released from the coating over time. The additives can be composed of biomolecules, that on release convey active ingredients to the immediate environment of the composite. It will be appreciated that non-biomolecule additives can perform this function, for example, radio-isotopes. The additives can also be of any material that provides or increases the electronic conductivity of the coating.

In one embodiment, the additives may be released on degradation of the polymer. This can provide a means of slow release in the immediate environment of the composite.

In another embodiment, the additives can be released on electrical stimulation. This can be used to induce highly effective triggered and local release of the additive.

### Substrate:

The term “substrate” as used herein does not include within its scope the surface utilised for the initial preparation of the nanotubes. Accordingly, it does not include silicon or quartz, the commonly used surfaces on which nanotubes are grown.

The substrate of the present invention comprises any material capable of physically retaining the nanotubes, or part thereof.

Generally the substrate is a polymeric material. The substrate can also be non-polymeric, for example an ionic liquid that can be subsequently gelled. Gelling can occur by several means, by addition of nanoparticles, or formation of a polymer within the ionic liquid. The substrate can be biomolecular, including polymeric and non-polymeric biomolecules. The substrate can be a combination of polymer, non-polymer, biomolecular materials. The substrate can also include additives.

The additives may be the same or different to the additives of the nanotube coating.

Polymers that are suitable for use as the substrate in the present invention are electronic conductors including polyethylene, polyethylenedioxythiophene (PEDOT), soluble polypyrroles, polythiophenes, polyanilines and/or even nanodispersions of these materials.

Other suitable polymer substrates include, but are not limited to, acrylate polymers such as poly(methyl methacrylate), poly(vinyl acetate-acrylate) and poly(vinyl acetate-ethylene); acrylic acid polymers such as poly(acrylic acid), poly(vinyl acetate), polyvinylpropionate, polyacrylic esters and polyacrylamides, polyacrylonitriles; chlorinated polymers such as poly(vinyl chloride), poly(vinylidene chloride), poly(vinyl chloride-ethylene), poly(vinyl chloride-propylene) and vinylchloride-acrylate polymers; fluorinated polymers such as polytetrafluoroethylene, poly(vinyl fluoride), poly(vinylidene fluoride), poly(vinyl fluoride-ethylene) and poly(vinyl fluoride-propylene); styrenic polymers such as polystyrene, poly(styrene-co-butadiene), styrene-acrylate copolymers and poly(styrene-β-isobutylene-β-styrene (SIBS); polyurethanes; natural rubber, synthetic rubber polymers such as silicone rubber, Silastic™, copolymers thereof and combinations thereof.

Poly(styrene-β-isobutylene-β-styrene)(SIBS) is a soft, elastomeric triblock copolymer [2] that has proven to be an effective biomaterial due to its superior biostability and biocompatibility [3]. Boston Scientific developed the first commercial application of SIBS as a drug-delivery coating for cardiac stents [4]. In pre-clinical trials Paclitaxel, released from SIBS-coated stents, was found to prevent the proliferation and invasion of smooth muscle cells that contributes to in-stent restenosis [3], while allowing growth of the desirable endothelial cells, leading to re-endothelialisation of the stent and reduction of the risk of stent-related thrombosis.

The term “biomolecule” generally refers to molecules or polymers of the type found within living organisms or cells and chemical compounds interacting with such molecules. Examples include biological polyelectrolytes such as hyaluronic acid (HA), chitosan, heparin, chondroitin sulphate, polyglycolic acid (PGA), polylactic acid (PLA), polyamides, poly-2-hydroxy-butyrate (PHB), polycaprolactone (PCL), poly(lactic-co-glycolic)acid (PLGA), protamine sulfate, polyallylamine, polydiallyldimethylammonium, polyethylene imine, eudragit, gelatin, spermidine, albumin, polyacrylic acid, sodium alginate, polystyrene sulfonate, carrageenin, carboxymethylcellulose;

nucleic acids such as DNA, cDNA, RNA, oligonucleotide, oligoribonucleotide, modified oligonucleotide, modified oligoribonucleotide and peptide nucleic acid (PNA) or hybrid molecules thereof;
polyaminoacids such as poly-L-lysine, poly-L-arginine, poly-L-aspartic acid, poly-D-glutamaic acid, poly-L-glutamaic acid, poly-L-histidine and poly-(DL)-lactide; proteins such as growth factor receptors, for example NT3, BDNF, catecholamine receptors, amino acid derivative receptors, cytokine receptors, lectins, cytokines and transcription factors;
enzymes such as proteases, kinases, phosphatases, GTPases and hydrolases;
polysaccharides such as cellulose, amylose and glycogen; lipids such as chylomicron and glycolipid; hormones such as amino-derived hormones, peptide hormones and steroid hormones;
stem cells and stem-like cells.

Polyelectrolytes are polymers having ionically dissociable groups, which can be a component or substituent of the polymer chain. Usually, the number of these ionically dissociable groups in the polyelectrolytes is so large that the polymers in dissociated form (also called polyions) are water-soluble. Depending on the type of dissociable groups, polyelectrolytes are typically classified as polyacids and polybases. When dissociated, polyacids form polyanions, with protons being split off, which can be inorganic, organic and biopolymers. Polybases contain groups which are capable of accepting protons, e.g., by reaction with acids, with a salt being formed.

The structures of some biomolecules suitable for use in the composite of the present invention are set out below:

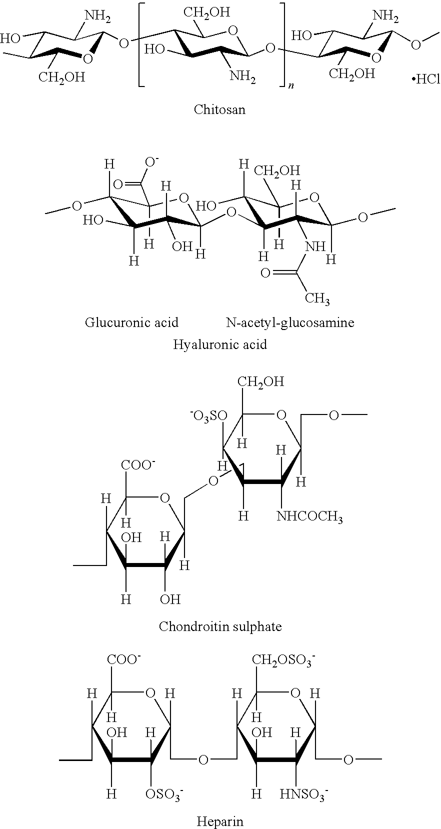

It will be appreciated that any of the biomolecule referred to above may include functional groups to allow further control of the biointeraction such as biomolecules which convey active ingredients for example drugs, hormones, growth factors, antibiotics, hormones, MRNA, DNA, steroids, antibodies, stem cells, stem-like cells and/or radioisotopes. Drugs envisaged here include but are not limited to antiinflammatory drugs such as dexamethasone, anticonvulsants such as valproic acid, phenyloin and levetericetam, antibacterials such as valproxen, cell inhibitory molecules such as paclitaxel. The biomolecule can also be chosen depending on the desired application, for example, if the composite was to be used to promote or inhibit adhesion of certain cell types it may be advantageous to use biomolecules which promote nerve or endothelial cell growth or inhibit smooth muscle cell growth (fibroblasts). Accordingly, applications such as orthopedics, ear implants are envisaged where the composite can be utilised as a scaffold structure for adherence between tissue and bone.

The biomolecule can include a monomer for example pyrrole and/or an oxidant, for example FeCl₃. In such embodiments, biomolecule can be rendered conductive by subsequent electrochemical or chemical oxidation if one or more monomers are present, or by vapour phase polymerisation if one or more oxidants are present in the substrate.

More than one biomolecule may be present in the composite of the present invention. The choice of the biomolecule will be determined by the end use of the structure.

### Additives

It will be appreciated that the additives may be utilised anywhere in the composite. For example, in the substrate, the nanotube coating and/or the metal or metal oxide layer. The additives may confer properties to the substrate and may also be released from the substrate and/or nanotube coating to distribute actives or other ingredients to the immediate environment of the composite.

Suitable additives include one or more of electrically conductive polymers as defined above; biomolecules described above; radio-isotopes; nanotubes such as carbon nanotubes, metal oxide nanotubes such as titanium dioxide nanotubes, metal nanorods and peptidyl nanotubes; metal networks such as metal salts of Au and/or Pt, salts, for example LiClO₄ (in particular added to polyethylene oxide) to render the substrate and/or coating ionically conductive; ionic liquids to achieve ionic conductivity; and/or a combination thereof. This may provide the composite with the characteristics of a conducting interconnecting substrate, or conducting interconnecting nanotube coating, which can contain a biologically significant molecule.

The additives may be included in the substrate, coating metal and/or metal oxide layer in the form of a dispersion.

The additive may be present in an amount in the range of 1-50% based on the total weight of the composite.

In the embodiment where the additive is a biomolecule, the biomolecule may be present in an amount in the range of 1-50% based on the total weight of the composite.

### Preparation of Composite

The preparation of the composite involves a first step of preparing the nanotube, preferably aligned carbon nanotube layer. This can be prepared by pyrolysis of iron phthalocyanine (FePc) using a quartz plate. Aligned carbon nanotubes can be prepared by any means for the purposes of this invention. The substrate is then integrated to the prepared nanotubes. The present invention is not limited by the step of first preparing the nanotube layer. A pre-prepared nanotube and/or carbon nanotube layer may also be utilised.

In one embodiment the above described substrate material for example as polymers and/or biomolecules, can be cast, or imbibed on the nanotube structure, preferably aligned nanotube structure, from a solvent based solution/dispersion. The solvent would subsequently evaporate leaving the polymer and/or biomolecules.

An alternative would be to use an ionic liquid, for example

### EMI⁺TFSI⁻.

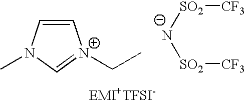

Some ionic liquids are solid at room temperature. Alternatively, the ionic liquid can be gelled by addition of nanoparticles such as nanotubes or by formation of a polymer within the ionic liquid, for example polymethyl methacrylate formation with EMI⁺TFSI⁻ gives rise to a “solid” ionic liquid electrolyte.

Alternatively, sputter coating techniques, and/or electrophoretic deposition can be utilised to integrate the substrate material onto the nanotube layer.

In one embodiment, a process for preparing a nanostructured composite comprises the steps of: providing a nanotube layer; providing a dispersion comprising dispersing media, and substrate optionally comprising a biomolecule; and casting the dispersion onto the nanotube layer, and forming nanotube/substrate composite structure.

The term “media” is used in its broadest sense and refers to any media which is capable of dispersing the substrate.

The substrate can be applied to the nanotube layer in the form of a dispersion which comprises a dispersing media and a substrate. Suitable concentrations of substrate in the dispersing media are in the range of 1% (w/v) to 75% (w/v), preferably 5% (w/v) to 50% (w/v), further preferably 15% (w/v) to 25% (w/v). For example, the dispersing media can be a dispersion of SIBS dissolved in toluene. Suitable concentrations range from 15% (w/v) to 25% (w/v) of SIBS in toluene. CNTs can be included in the substrate, thus forming a substrate that has electrical conducting properties.

Any of the polymeric substrates referred to previously can be dissolved in a solvent to form the dispersing media. Any of the additives mentioned previously can also be included in this dispersing media. Suitable solvents include organic solvents such as toluene, N-methyl pyrrolidine (NMP), dimethyl propylene urea (DMPU) and tetrahydrofuran (THF) and/or water.

The dispersing media can include nanotubes, for example carbon nanotubes, ranging from concentrations of 0.001 to 5%, preferably 0.01% to 0.05%, further preferably 0.1 wt % to 1.0 wt % dissolved in aqueous media. In one embodiment, the aqueous media can include a range of aqueous biomolecule solutions. Any of the biomolecules referred to previously are suitable in this embodiment. For example, the dispersion can include single wall carbon nanotubes (SWNTs), double walled nanotubes (DWNTs), and multi walled nanotubes (MWNTs), while the biomolecules can include DNA, chitosan, hyaluronic acid and chondroitin sulphate. In this embodiment, the substrate is a conducting, interconnecting film which contains a biomolecule. The choice of biomolecule will be determined by the end use of the structure.

The length of the nanotube retained by the substrate may be in the range 10-100% of the substrate layer. One specific example can be described. A dispersion of SIBS can be cast onto the ACNTs that were originally grown on a quartz plate and left to dry in air. The SIBS based composite is then peeled from the quartz plate taking the aligned carbon nanotubes as part of an integrated structure. This ACNT/SIBS structure results in a biocompatible layer with highly conducting needles of carbon nanotubes protruding from it.

In a specific example, the substrate is PEDOT, in which case the casting of the substrate on to the ACNT layer involves coating Fe(111) sulfonates (20%) in ethanol solution onto ACNTs modified quartz plates, followed by drying at elevated temperature and exposure to EDOT vapour resulting in polymerisation. The PEDOT based composite is then peeled from the quartz plate with attached ACNTs.

In the event a substrate does not provide sufficient mechanical robustness to support the CNT array, further substrate material may be integrated onto the first substrate to add strength. For example, in the ACNT/PEDOT example described in the examples, the PEDOT film is 100 nm thickness across the entire film. A second coating of PVDF (10% w/w in acetonitrile solution) was cast onto the PEDOT film to provide the mechanical robustness required to peel the resultant flexible electrode film from the quartz plate.

A further embodiment of the preparation of the composite comprises a pre-integration step, involving deposition of one or more metal and/or metal oxide layers on the nanotube layer.

In a further embodiment, the deposition of the metal and/or metal oxide layer(s) may occur after the integration step, a post-integration step.

Preferably, the one or more metal and/or metal oxide layers are deposited prior to the substrate. The metallic material can be any metal or metal oxide, preferably Pt.

The deposition step can be conducted by any known methods of depositing a metallic material. Preferably, sputter coating deposition, electrophoretic deposition, atomic layer deposition may be utilised.

In a further embodiment, metal nanoparticles are deposited on to the nanotube layer, to increase the catalytic effect.

### EXAMPLES

Examples of suitable composites of the present invention include:
Aligned CNT/Pt/PVDF
Aligned CNT/SIBS
Aligned CNT/Pedot
Aligned CNT/PEDOT/PVDF
Aligned CNT/PLGA
Aligned CNT/Pedot/SIBS
Aligned CNT with Ppy coated CNT tips/Pedot
Aligned CNT/substrate is a CNT dispersion
Aligned CNT/CNT biomolecule dispersion
Aligned CNT/Ppy/SIBS
Aligned CNT/PVDF
Aligned CNT/PVDF/Pt nanoparticles

The amount of the carbon nanotube present as a percentage of the substrate can be in the range 1% to 50%. The amount of carbon nanotube present in determined by the ultimate use of the composite.

The length of the nanotube retained by the substrate can be in the range 10-100% of the height of the substrate layer.

### Properties and Applications of the Composite

### Electrical Conductivity:

The electrical conductivity of the nanostructured composites is in the range from 0.1 to 10 s cm⁻¹.

### Bioapplications:

The ordered CNT constructs with biomaterials and organic conductors will provide an effective interface with biological tissue for the treatment of disease. The interface will allow the release of trophic agents and delivery of electrical charge for applications such as the protection and regeneration of nerve fibres and provision of patterns of electrical stimulation. Examples of outcomes are the correction of deafness, spinal cord and nerve injury, drug resistant epilepsy, and improved arterial stents. In the case of deafness the constructs will be incorporated into a cochlear implant electrode array. An advantage over present designs is that the CNTs can lie beneath the basilar membrane or spiral lamina and more effectively release the trophic agents and electrical charge for maximal effect. When the bundle is positioned beneath these structures the CNTs can provide a sustained release of trophic agents. The CNTs can also penetrate the fibrous tissue and bone canaliculi and result in release and stimulation of the nerve fibres within the scala media of the cochlea. This is a distinct advantage for the development of advances electrode arrays. In the case of spinal cord and nerve injury the CNT constructs can provide a scaffold for nerve regeneration. The constructs can not only release trophic agents and electrical charge but stem cells.

### Electrodes for Energy Storage:

These electrode structures may also find application in the area of energy storage. In this case the polymer holding the structure together may be chosen to provide additional storage capacity, for example, conducting polymer such as polyaniline, polypyrroles or carbon nanotube containing formulations. For example, conventional batteries or capacitor structures or in the case where biocompatible polymers/conductors are used then biobatteries, biocapacitors.

Example 4d below shows use of ACNT/PEDOT/PVDF electrode in a Lithium-ion battery.

The results discussed in example 4 below indicate that this novel “free-standing” ACNT/PEDOT/PVDF membrane electrode, which is lightweight, flexible highly conductive, and mechanically robust, could be easily fabricated into a rechargeable battery without using a metal substrate or binder. In this lithium-ion battery, the weight of the electrode is reduced significantly compared with a conventional electrode made by coating a mixture containing an active material onto the metal substrate. The results also show that the capacity of the ACNT/PEDOT/PVDF electrode is 50% higher than that observed for free-standing SWNT paper. This has important implications for the use of aligned carbon nanotube-conductive polymer composites as a new. class of electrode materials in developing flexible rechargeable lithium-ion batteries and may lead to other applications of carbon nanotubes in flexible electronic devices.

### Electrode for Energy Conversion:

These electrode structures may find use in novel solar energy corrosion devices where the binding polymer is a conjugated polymer such as light-emitting polymers, such as poly(phenylene vinylene), poly(thiophene) or poly(methacrylates) and their derivatives.

The structures of some conjugated light-emitting polymers suitable for use in the composite are shown below:

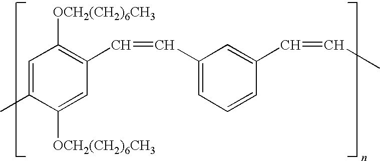

### Poly[(m-phenylenevinylene)-co-(2,5-dioctoxy-p-phenylenevinylene)]

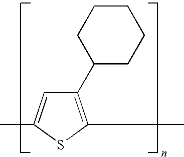

### Poly(3-cyclohexylthiophene-2,5-diyl)

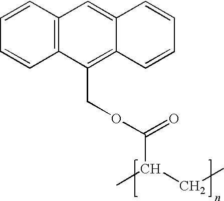

### Poly(9-anthracenylmethyl acrylate)

They may also find use in biofuel cells.

Advantages such as excellent electrocatalytic performance of ACNT/Pt/PVDF membrane with further advantages in that the polymer substrate provides a medium into which catalysts such as organo-metallics can be loaded. This results in a powerful and versatile electrode structure for catalysis.

Applications in the fields of ion transport and liquid and gas separation are envisaged.

### DESCRIPTION OF THE DRAWINGS

In the examples which follow, reference will be made to the accompanying drawings in which:

FIG. 1 is a schematic diagram showing combinations of aligned carbon nanotubes and polymer.

FIG. 2 shows high resolution SEM images of low and high ACNTs, density ACNTs and patterned ACNTs.

FIG. 3 shows high resolution SEM images of free standing ACNTs/SiBS membranes.

FIG. 4 shows high resolution SEM images of free standing ACNTs/PEDOT membranes.

FIG. 5 is a schematic diagram showing casting of CNT-biodispersion onto ACNTs and removal of the ACNT/CNT-biodispersion film in 1.0 M Na NO₃/H₂O at the scan rate of 20 mVs⁻¹.

FIG. 6 is a pulse diagram showing the high frequency, biphasic pulse used to clinically stimulate the composite film ACNT/PEDOT with Ppy (containing NT₃) coated on the exposed CNT tips. This pulse is used in the method of example 3b.

FIG. 7 is a graph showing the efficiency of release of nerve growth factor NT₃ from Ppy coating of CNT exposed tips of ACNT/PEDOT composite film.

FIG. 8 (results of example 3a) shows high resolution SEM images of L-929 cells on SIBS-ACNT structure.

FIG. 9 (results of example 3b) shows high resolution SEM images of L-929 cells on ACNT-PLGA structure.

FIG. 10 (results of example 3c) shows high resolution SEM images of L-929 cells on SWNT-SIBS-ACNT.

FIG. 11 shows high resolution SEM images of ACNT/PEDOT/PVDF membrane Electrodes; (a) after peeling (subsequent to stretching), and (b) deliberately stretched (≈15%).

FIG. 12 shows high resolution SEM images of free-standing highly flexible ACNT/PEDOT/PVDF composite film.

FIG. 13 shows the cyclic voltammogram of (1) ACNT/PEDOT/PVDF and (2) PEDOT/PVDF membrane electrodes in 1.0 M NaNo₃/H₂O at a scan rate of 20 mVs⁻¹.

FIG. 14 is a graph showing the discharge capacity vs. the cycle number of ACNT/PEDOT/PVDF electrode in a lithium-ion testing cell under a constant current density of 0.1 mA cm⁻².

FIG. 15 is a schematic representation of the procedures for the synthesis of the ACNT/Pt/PVDF membrane electrode. SEM micrographs of ACNT on (b) the quartz plate and (c) the Pt/PVDF polymer membrane. And (d) digital photograph illustrating the high flexible ACNT/Pt/PVDF membrane electrode.

FIG. 16 is a schematic electrodeposition of Pt nanoparticles onto the ACNT/Pt/PVDF membrane electrode, (b) SEM micrograph of the Pt nanoparticles coated ACNT/Pt/PVDF, and (c) energy dispersive X-ray analysis of the Pt nanoparticles coated ACNT.

FIG. 17 is a cyclic voltammogram obtained in 1 M H₂SO₄/H₂O using the nanoparticle -ACNT/Pt/PVDF membrane. Scan rate: 0.2 Vs⁻¹.

FIG. 18 is a cyclic voltammograms of methanol oxidation at (a) the Pt coated glass slide, (b) the ACNT/Pt/PVDF membrane electrode, and (c) the nanoparticle-ACNT/Pt/PVDF membrane electrode in 1 M CH₃OH/1 M H₂SO₄/H₂O solution. Scan rate: 0.02 Vs⁻¹.

FIG. 19 is a chronoamperogram of methanol oxidation at the nanoparticle-ACNT/Pt/PVDF membrane electrode using a constant potential at +0.7 V.

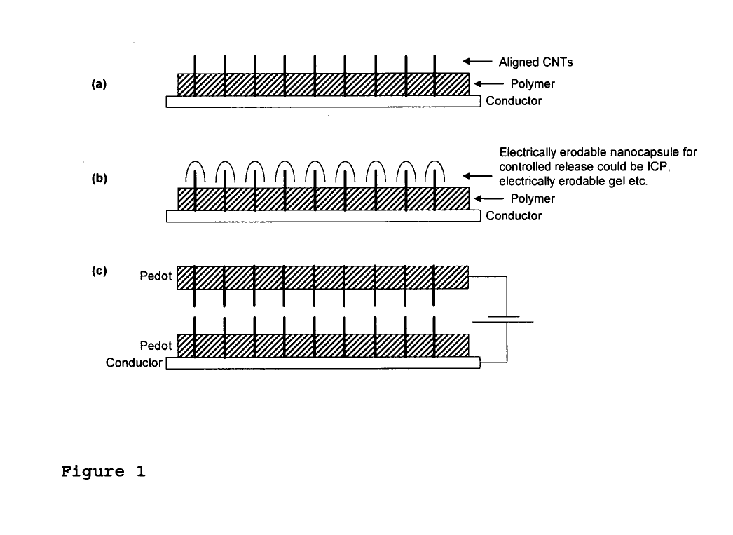

### EXAMPLES

The invention will now be described with reference to the following non-limiting examples.

### Instrumentation:

SEM images were acquired using a Hitachi S-900 field-emission scanning electron microscope (FESEM) Samples for FESEM were sputter coated with chromium prior to analysis. The nanotube films were imaged with no coating.

Raman spectroscopy measurements were performed using a Jobin Yvon Horiba HR800 Spectrometer equipped with a He:Ne laser operating at a laser excitation wavelength of 632.8 nm utilizing a 300-line grating.

Electrical conductivity measurements were carried out using a conventional four-point probe method at room temperature.

Electrochemical capacitance was calculated from the slope of anodic current amplitude when graphed against the scan rate, obtained from cyclic voltammetry at different potential scan rates, in phosphate buffered saline solution (PBS −0.2M pH 7.4) with Ag/AgCl reference electrode. Cyclic Voltammetry were performed using an eDAQ e-corder (401) and potentiostat/galvanostat (EA 160) with Chart v5.1.2/EChem v 2.0.2 software (ADlnstruments) and a PC computer.

### Example 1

### Preparation of Integrated ACNTs/SIBS Structure

### Materials

The ACNTs are prepared by pyrolysis of iron(II) phalocyanine (FePc, Aldrich) using the Atomate Advanced Thermal CVD System (Atomate Corporation, USA). Poly (stynene-β-styrene) (SIBS) is supported by Boston Scientific Co. USA.

### Procedure

### a) Preparation of Aligned Carbon Nanotubes

The aligned carbon nanotubes were prepared by pyrolysis of iron (II) phthalocyanine (FePc) [6]. The pyrolysis of FePc was performed under Ar/H₂ atmosphere using a quartz plate in a flow reactor consisting of a quartz glass tube and a dual furnace with two independent temperature zones (10 cm apart). In this study, 0.25 g FePc (in a quartz boat) and a pre-cleaned quartz glass plate were placed over the first and second zones, respectively, in the quartz tube reactor. A gas flow of Ar/H₂ (2:1 by v/v, 80:40 cm³/min) mixture was introduced into the quartz tube while heating up the second zone. After the second zone reached a temperature of 900° C., the first zone was heated up to 600° C. and kept for 10 min. Thereafter, both zones were kept at 900° C. for an additional 10 min for the growth of nanotubes. The resulting aligned carbon nanotubes appeared on the quartz plate as a black layer.

### b) Integration of SIBs.

Dispersions of SIBS with concentrations ranging from 15% (w/v) to 25% (w/v) dissolved in toluene were prepared using magnetic stirring for 90 minutes at 50° C. These high viscosity solutions were cast onto ACNTs that were originally grown on a quartz plate as in (a) above. This was left to dry in the air. Then the SIBS-based membranes were peeled from the quartz plates taking the aligned carbon nanotubes as part of an integrated structure. This ACNTs/SIBS structure results in a biocompatible layer with highly conducting needles (with the mechanical properties of nanotubes protruding from it).

### Example 2

### Preparation of Integrated ACNTs/CNT-Biodispersion Structure

### Procedure

a) Preparation of aligned carbon nanotubes as described above in example 1.
b) Integration of CNT-Biodispersion structure Dispersions containing CNTs ranging from concentrations of 0.1 wt % to 1.0 wt % dissolved in a range of aqueous biomolecule solutions have been prepared. The biomolecules are dissolved in Milli-Q water at 90° C. before adding the required amount of CNT to this solution. The CNT-biomolecule solutions are then sonicated for between 30 and 45 min using a high energy sonicator (utilizing a 1 sec ON and 2 sec OFF pulse program) to form a stable CNT-biodispersion. The CNTs used have been single wall carbon nanotubes (SWNTs), double walled carbon nanotubes (DWNTs) and multi walled carbon nanotubes (MWNTs) whilst the biomolecules have been DNA, chitosan, hyaluronic acid and chondroitin sulphate. Casting of these CNT-biodispersion facilitates the formation of robust free standing films comprising solely of the CNT and biomolecules of choice. This configuration provides a way to incorporate a conducting interconnecting film which can contain a biologically significant biomolecule.

### Example 3

### Feasibility of Growing Mammalian (L-929) Cells on Aligned CNT Structures.

### Example 3a

### ACNT-SIBS Composite Film

i) The experimental method of example 1 was followed to produce integrated ACNT/SIBS structure. A dispersion of SIBS with concentration of 20% (w/v) dissolved in toluene was utilised.

### ii) Pretreatment:

The ACNT-SIBS composite was cut to size to fit into the wells of a 96-well plate: 6 mm diameter discs. Wells containing ACNT-SIBS discs were washed twice in culture media (soaked overnight), rinsed in water then twice in 70% EtOH; dried from 70% EtOH in a sterile environment then sterilized under UV light for 20 mins.

iii) Cell Culture:

L-929 cell culture: (Sources of L-929 cell culture?) 5,000 cells were seeded into each well of 96-well plates containing the materials and cultured for 72 hours. Cells were stained with calcein, which fluoresces green in metabolically active cells and enables visualization of the cells on opaque materials.

### iv) Calcein Staining:

Calcein AM (1 mM in DMSO stock) was added at 5 uM (1 in 200 dilution) to cells in culture media and incubated for 15 mins under cell culture conditions (37° C., 5% CO₂) rinsed twice by removing media and replacing with fresh media. Visualise and image using fluorescence microscopy.

### v) Results (FIG. 10):

As can be seen from FIG. 10, good cell growth occurs on both sides of the ACNT-SIBS composite.

### Example 3b

### ACNT/PLGA Composite Film

The experimental method of example 1 was followed to produce ACNT/PLGA composite film. A layer of PLGA (15% w/w in acetone) was utilised. A free-standing ACNT/PLGA membrane electrode can be peeled off from the quartz plate after complete evaporation of the solvent.

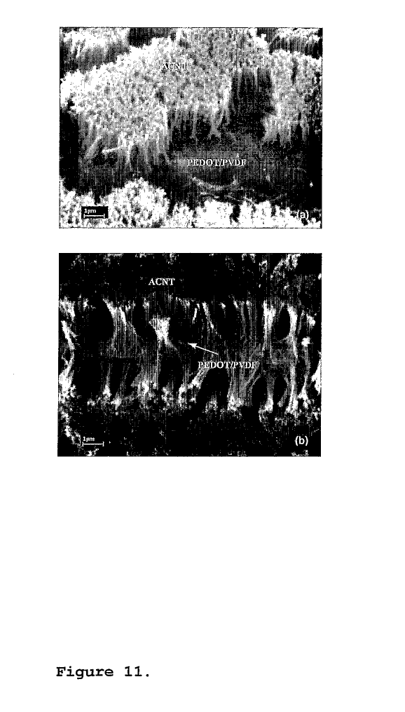

The feasibility of growing mammalian (L-929) cells on ACNT/PLGA structures was investigated according to the experimental method of example 3a. The results are shown in FIG. 11 and cell growth was observed on both sides of the ACNT/PLGA structure.

### Example 3c

### SWNT-SIBS-ACNT Composite Film

The experimental method of example 1 was followed to produce SWNT-SIBS-ACNT composite film. 0.3% w/w SWNT was dispersed in 15% w/w SIBS in toluene for 45 minutes in a Vibra Cell VC-5-5 ultrasonicator. Then a layer of SIBS/SWNT was cast directly onto the preheated ACNT/quartz plate. The resulting ACNT/SWNT-SIBS composite film is peeled from the quartz plate after the evaporation of toluene.

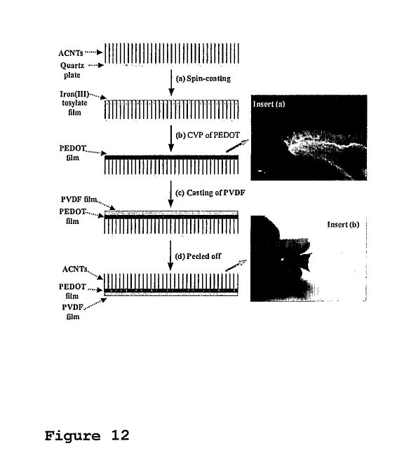

The feasibility of growing mammalian (L-929) cells on SWNT/SIBS-ACNT structures was investigated according to the experimental method of example 3a. The results are shown in FIG. 12 and excellent cell growth is observed on both sides, the ACNT side and the SWNT side of the structure.

### Example 4

### Preparation of Integrated ACNTs/PEDOT/PVDF Structure

### Procedure:

a) Preparation of aligned carbon nanotubes as described above in example 1.

### b) Integration of PEDOT/PVDF

Following production of the aligned CNTs on a quartz plate, PEDOT film was deposited onto the CNT array by chemical vapour phase polymerisation. A thin film of ferric p-toluenesulfonate (Fe(III) tosylate) was coated on the ACNT array using a spin coater (Laurell Tech. Co.) at a speed of 1000 rpm for 1 min from a 10% (w/w) Fe(III) tosylate solution in ethanol. The Fe(III) tosylate coated ACNT array was placed directly into an oven at 80° C. for 3 min to quickly evaporate the ethanol, thereby forming a good quality continuous Fe(III) tosylate film. The sample was then exposed to 3,4-ethylenedioxythiophene (EDOT) monomer vapour in the vapour phase polymerization (VPP) chamber at 60° C. [7]. After 30 min, the sample was removed from the chamber and a blue film was visible on the quartz plate indicating the formation of PEDOT. Following air-drying for 1 h, the PEDOT coated ACNT array was washed in pure ethanol to remove unreacted EDOT monomer as well as Fe ions. The PEDOT modified ACNT array was then dried in a fumehood. The PEDOT film measured 100 nm thickness across the entire film. A second coating, consisting of poly(vinylidene fluoride) (PVDF), was cast onto the PEDOT film from a 10% (w/w) PVDF acetonitrile solution. The PVDF layer measured 0.5 μm thickness across the entire film provided the mechanical robustness required to peel the resultant flexible electrode film from the quartz plate.

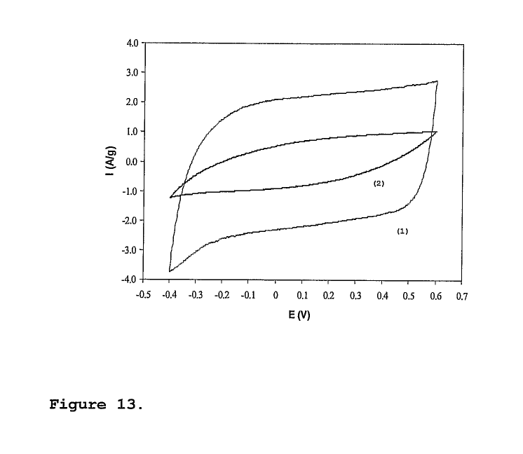

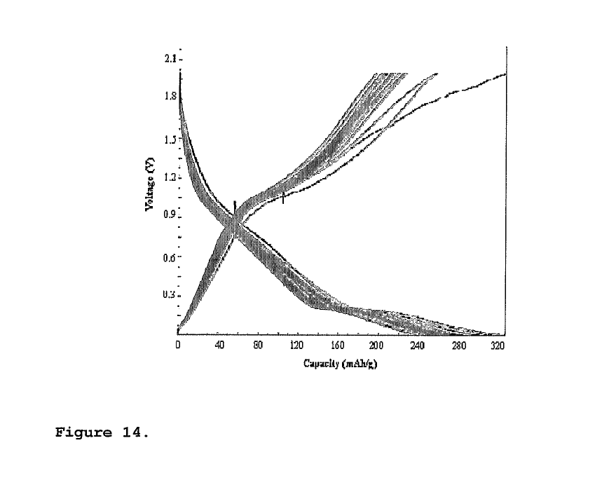

An example of this free-standing, highly flexible composite is shown in FIGS. 13 and 14.

### c) Conductivity

The conductivity of the ACNT/PEDOT/PVDF electrode was determined using a standard 4-probe system (Jandel Model RM2). The ACNT/PEDOT/PVDF membrane electrode had an electronic conductivity over 200 S cm⁻¹, which is significantly higher than that measured for an ACNT/PVDF electrode (between 2 to 20 S cm⁻¹) prepared under identical conditions without PEDOT layer in the middle. This result is an average of 10 measurements across the sample, with less than 10% deviation between each measurement, confirming the uniformity of the film structure. The PEDOT layer assists in producing interconnectivity between the aligned parallel tubes.

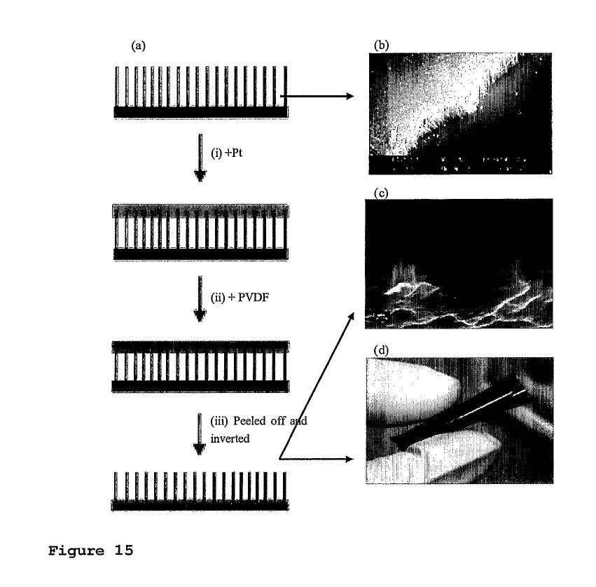

The electrochemical characteristics of the ACNT/PEDOT/PVDF nanostructured electrode were determined using a three-electrode cell filled with 1.0 M NaNo₃/H₂O and comprising a working electrode (ACNT/PEDOT/PVDF), an auxiliary electrode (platinum mesh), and an Ag/AgCl reference electrode at room temperature. The cyclic voltammogram (CV) (FIG. 15(1)) shows a rectangular shape, indicative of the highly capacitive nature of the ACNT/PEDOT/PVDF electrode with rapid charge/discharge characteristics [11] when compared with PEDOT/PVDF (FIG. 15(2)). This electrode was cycled for 50 cycles and no obvious degradation was observed.

d) Electrode assembled into a lithium-ion battery for testing.

A 1 cm² nanostructured ACNT/PEDOT/PVDF electrode was assembled into a lithium-ion battery for testing (Neware, Electronic Co.) using method described at (8). The Lithium-ion testing cell was assembled in an argon-filled glove box (Mbraun, Unilab, Germany) by stacking a porous polypropylene separator containing liquid electrolyte between the ACNT/PEDOT/PVDF electrode and a lithium foil counter electrode. The electrolyte used was 1.0 M LiPF₆ in a 50:50 (v/v) mixture of ethylene carbonate and dimethyl carbonate supplied by Merck KgaA, Germany. The cell was cycled at room temperature between 0.0 and 2.0 V at a constant current density of 0.1 mA cm⁻² for the time required to reach the potential limit.

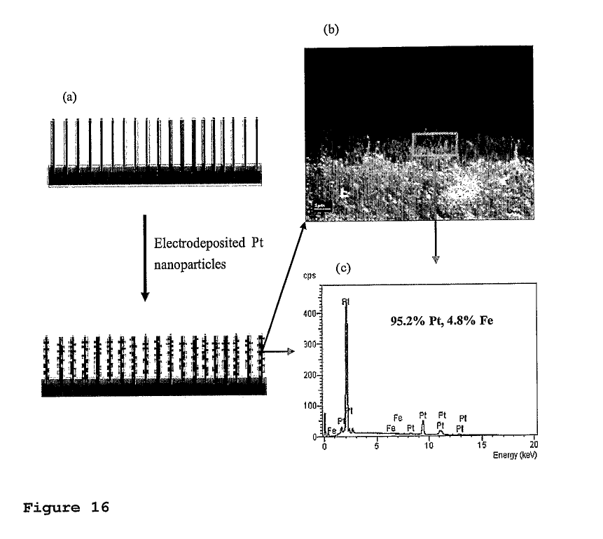

The typical charge-discharge (see FIG. 16) profiles display stable charge-discharge curves during cycling; indicative of stable electrochemical performance by this free-standing ACNT/PEDOT/PVDF membrane electrode. The discharge capacity versus the cycle number for the above cell is shown in FIG. 16. the first cycle of this electrode exhibits an enormous irreversible capacity, which can be attributed to the formation of a solid electrolyte interface (SEI) layer on the surface of the electrodes [9]. However, a highly stable discharge capacity of 265 mAh g is observed after 50 cycles. This is significantly higher than the value obtained previously for SWNT paper (173 mAh g⁻¹) under identical working conditions [10]. This is attributed to the high accessible surface area (140 cm²/cm⁻²) of the aligned carbon nanotubes which, coupled with the robust polymer layer, provides a mechanically stable array. The CNTs in ACNT/PEDOT/PVDF electrode maintain their nanostructured architecture, while the CNTs in SWNT paper prepared via vacuum filtration aggregate to form bundles of CNTs and thereby decrease the electroactive surface area of the electrode. This is reflected in the stable long-term electrochemical performance of these electrodes in a lithium-ion battery. No degradation was observed over 50 charge-discharge cycles.

Another significant improvement is that this free-standing ACNT/PEDOT/PVDF electrode with excellent electronic and mechanical properties does not require a metal substrate (copper foil) as is normally employed to support the active materials in a Lithium-ion battery [11]. For a typical anode (1 cm²) this equates to 14 mg of copper compared to 2 mg of PVDF, which still could be decreased by optimizing the process. This would significantly decrease the weight of the anode in a lithium-ion battery, or allow more active material per unit mass to increase the capacity per battery unit. The other advantage of this copper-free electrode is that it may contribute to the improvement of the long-term battery performance; without copper dissolution caused by impurities in the electrolyte. Due to the chemical and electrochemical stability of PEDOT and PVDF, the impurities in the electrolyte would not cause the same problem as that for copper foil during the long-term battery performance. This may explain the stable electrochemical performance observed when used in a Lithium-ion battery.

### Example 5

### Experimental Method for Coating PPY Containing the Nerve Growth Factor NT₃ on to CNT Tips of ACNT/SIBS/PEDOT/PVDF composite.

The Ppy layer was deposited onto the aligned CNT forest by CV (chemical vapourisation) growth. A polymerisation solution containing 0.2M pyrrole, 0.05M pTS and 2 ppm NT-3 was used as the electrolyte in a three electrode cell, consisting of the CNT-array (WE), Pt mesh (CE), and a Ag/AgCl reference electrode (connected via a 3M NaCl salt bridge). Two very similar growth conditions were used to deposit the Ppy layer. Voltage was scanned at 50 mV/sec between −0.6V and either 1.0V or 1.1V for 20 cycles. These samples were analysed by RAMAN, which indicated a layer of Ppy/pTS/NT-3 had been deposited.

### Example 5a

### Electrically Stimulated Release Experiments:

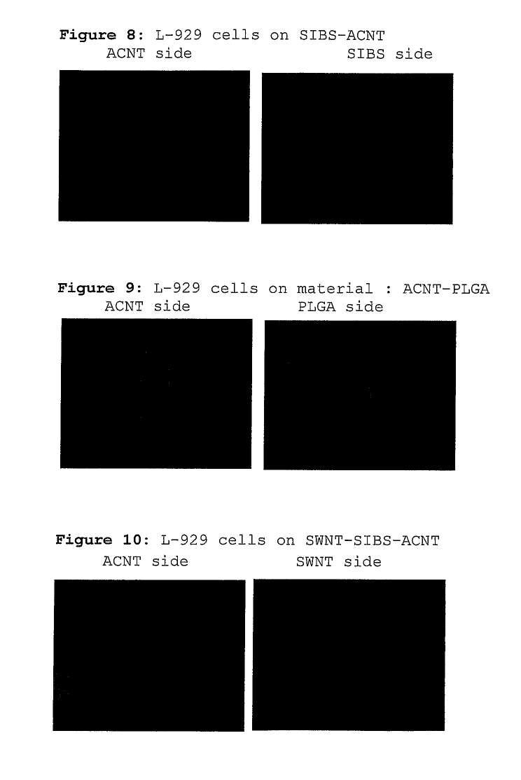

Release studies on the films were then undertaken, with iodinated NT-3 being incorporated into a film grown under identical conditions (CV growth from −0.6 to 1.0V). After growth, the film was washed and placed into a two electrode-cell, with stainless steel mesh as a counter electrode, and an electrolyte consisting of 0.90 saline. A clinical stimulator was used to stimulate the cell, applying a high frequency, biphasic pulse to the cell (see FIG. 8). As the geometric surface area of the CNT-array was approximately 2 mm×5 mm (0.1 cm2), this resulted in a current density of 2 mA/cm2. The electrolyte was completely removed and replaced after 1 h, and 1, 2 and 4 days of stimulation. All samples were subsequently gamma counted to determine the amount of NT-3 release from the CNT array.

### Results:

As can be seen from the results graphed in FIG. 9, the efficiency of release was much greater when the aligned CNT electrode structure was used compared to the standard film.

### Example 6

### Synthesis of the Pt/ACNT/PVDF Composite Membrane

Aligned carbon nanotubes were prepared on a quartz plate (2×4 cm²) using chemical vapor deposition. As schematically illustrated in FIG. 15(a), a suitable layer of Pt was sputter coated onto the ACNT/quartz plate at 30 mA for 30 minutes using a Dynavac Magnetron Sputter Coater (Model SC100MS) (FIG. 15a(i)). A polymer layer PVDF was subsequently cast onto the top of the Pt/ACNT arrays from a 10% (w/w) PVDF/NMP solution (FIG. 15a(ii)). After complete drying of the PVDF, the resulting PVDF/Pt/ACNT membrane can be peeled off from the quartz plate and inverted for further use (FIG. 15a(iii)).

### Example 6a

### Incorporation of Pt Nanoparticles into the ACNT/Pt/PVDF Membrane

The freestanding Pt/ACNT/PVDF membrane was further manipulated by the electrodeposition of Pt nanoparticles (FIG. 16a) from 0.01 M H₂PtCl₆/0.5M NaNO₃/H₂O using cyclic voltammetry (CV). The potential was cycled between 0 and +0.6 V (vs. Ag/AgCl) for 2 cycles at 0.05 Vs⁻¹.

### Example 6b

### Methanol Electro-Oxidation

The electrocatalytic performance of the nanoparticle-ACNT/Pt/PVDF membranes for the electro-oxidation of methanol was evaluated using either cyclic voltammetry over the potential range 0˜1.2 V or a constant potential (Eapp=0.70 V) in 1 M MeOH/1 M H₂SO₄/H₂O solution.

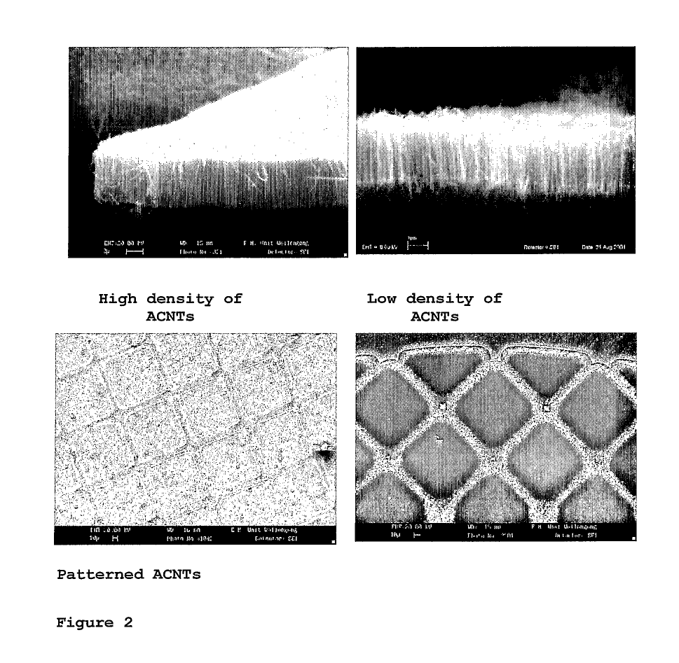

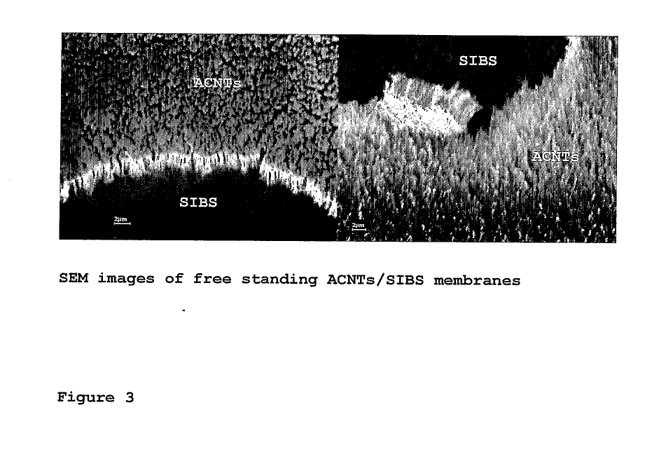

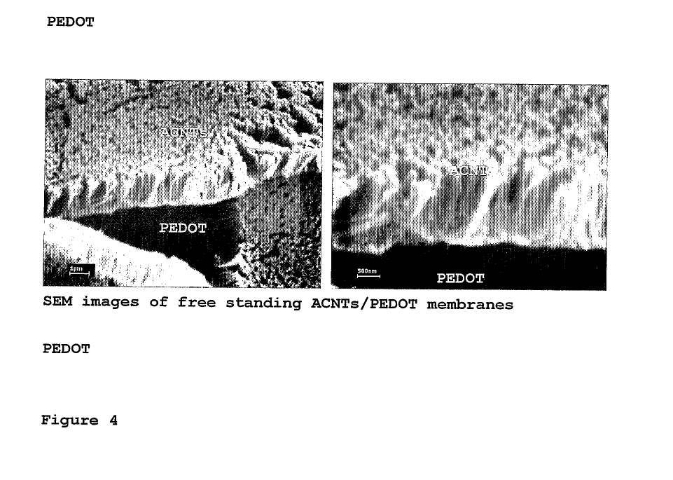

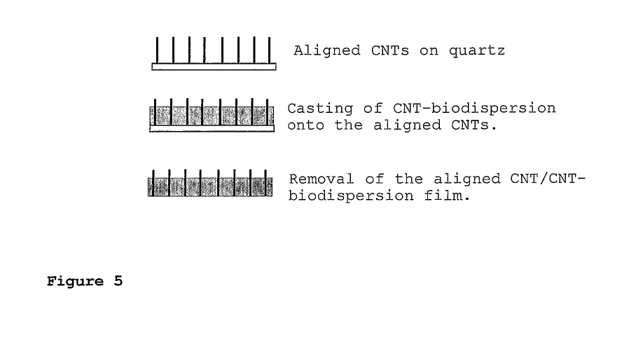

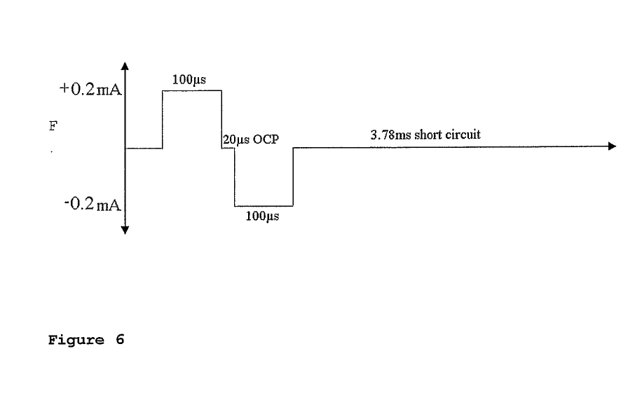

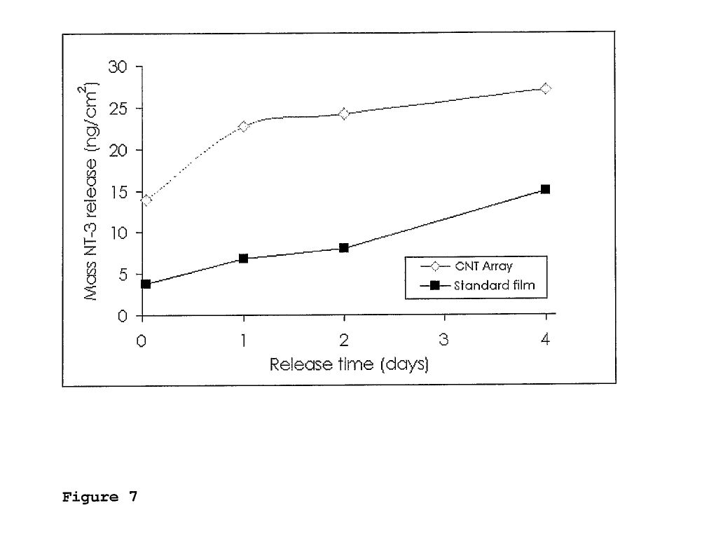

The electrodeposition of Pt nanoparticles onto the ACNT/Pt/PVDF membrane was schematically shown in FIG. 16(a). Nanoparticles with size of ca. 5˜10 nm are prominent on CNT with the highly ordered aligned forest structure maintained (FIG. 2b). EDX analyzer detects 95.2% Pt and 4.8% Fe (residual iron during the preparation of ACNT) from these particles covered CNT (FIG. 2c), confirming the successful deposition of Pt onto the ACNT/Pt/PVDF membrane.

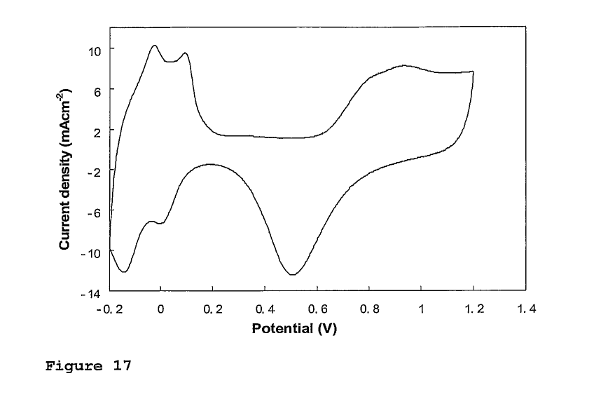

FIG. 17 shows the cyclic voltammogram obtained using the nanoparticle -ACNT/Pt/PVDF membrane electrode in 1 M H₂SO₄. Two redox couples related to the adsorption and desorption of hydrogen were observed. The current levels obtained indicate a very high surface area for the platinum nanoparticles.

### Example 6c

### Electro-Oxidation of Methanol

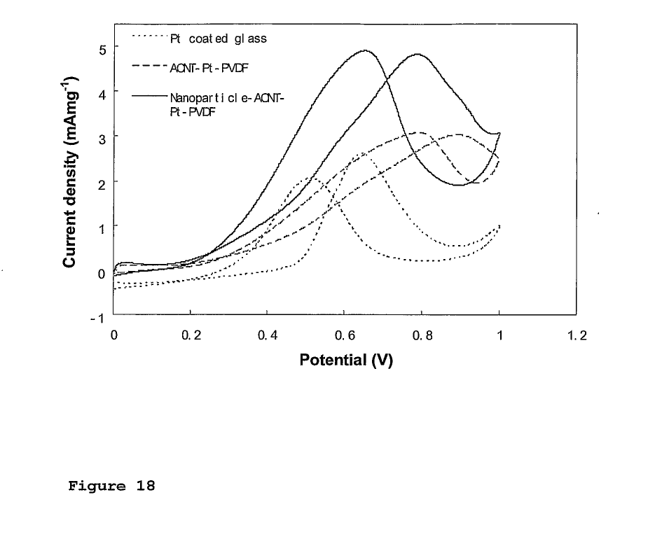

The use of the membrane electrode for methanol oxidation was evaluated using cyclic voltammetry in an aqueous solution containing 1 M methanol and 1 M H₂SO₄ (FIG. 18). The activity of the membrane after electrodepositing 0.02 mg·cm⁻¹ Pt nanoparticles shows about 1.7 times higher than that of the ACNT/Pt/PVDF membrane and 1.9 times higher than that of the Pt coated glass slide. The excellent catalytic performance of the Pt nanoparticles can be observed.

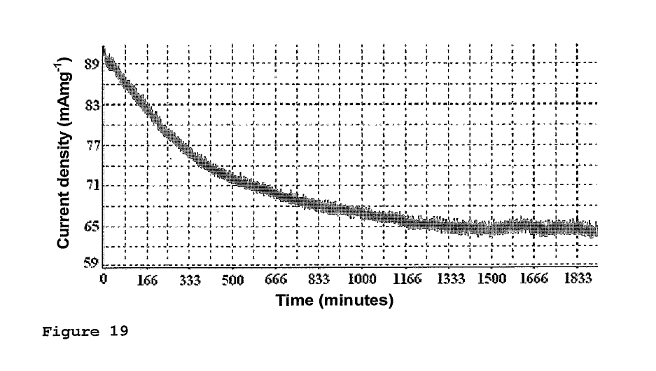

A constant potential (+0.7 V) was also used to investigate the catalytic activity of the resulting membrane for anodic oxidation of methanol. As shown in FIG. 19, a steady value of 64 mA·mg⁻¹ was obtained and remains consistent at 64 mA·mg⁻¹ for another 12 hours, suggesting the facile removal of poisonous intermediates such as CO. The observed steady current density for the nanoparticle-ACNT/Pt/PVDF membrane is 2.5 times higher than that of the ACNT/Pt/PVDF membrane while the increased amount of Pt was only 0.02 mg·cm⁻², indicating the excellent catalytic activity of the electrodeposited Pt nanoparticles.

### REFERENCES

¹ Li, W Z., Xie, S S., Qian, L X., Chang, B H., Zou, B S., Zhou, W Y., Zhao, R A., Wang, G., Large-scale synthesis of aligned carbon nanotubes, Science 1996; 274:1701-1703.
² Kaszas G, Puskas J E, Hagar W G, Kennedy J P, Thermoplastic elastomers of isobutylene and process of preparation. 1990: USA.
³ Ranade S V, Richard R E, Helmus M N. Styrenic block copolymers for biomaterial and drug delivery applications. Acta Biomaterialia 2005; 11:137-44.
⁴ Grube, E, Silber S, Hauptmann K E, Mueller R, Buellesfeld L, Gerckens U, et al. Six- and twelve-month results from a randomized, double-blind trial on a slow-release paclitaxel-eluting stent for de novo coronary lesions. Circulation 2003; 1071:38-42.
⁵ D C. Li, L M. Dai, S. Huang, A W H. Mau, Z L. Wang, Structure and growth of aligned carbon nanotube films by pyrolysis Chemical Physics Letters 2000; 316:349-355.
⁶ Dai, L M., Patil, A., Gong, X., Guo, Z., Liu, L., Liu, Y., Zhu, D., Aligned Nanotubes, Chemical Physics Chemistry 2003; 4:1150-1169.
⁷ B. Winther-Jensen, J. Chen, K. West, G. G. Wallace, Macromolecules 2004, 37, 5930.
⁸ J. Chen, J. Wang, C. O. Too, G. G. Wallace, J. Power Sources 2006, 708.
⁹ E. Frackowiak, S. Gautier, H. Gaucher, S. Bonnamy, F. Beguin, Carbon 1999, 37, 61.
¹⁰ S. H. Ng, J. Wang, Z. P. Guo, J. Chen, G. X. Wang, H. K. Liu, Electrochimica Acta, 2005, 51, 23.
¹¹ M. Zhao, H. D. Dewald, R. J. Staniewicz, Electrochimica Acta 2004, 49, 683.

It will be understood to persons skilled in the art of the invention that many modifications may be made without departing from the spirit and scope of the invention.

1. A nanostructured composite comprising nanotubes partially embedded and physically retained by a substrate, forming a nanotube substrate structure wherein the nanotubes protrude from the substrate resulting in exposed nanotube tips.

2. The composite according to claim 1 wherein the nanotubes are selected from one or more of the group consisting of carbon nanotubes, metal oxide nanotubes and/or peptidyl nanotubes.

3. The composite according to claim 1 or 2, wherein the nanotubes are aligned carbon nanotubes.

4. The composite according to any one of claims 1 to 3, wherein the nanotubes are SWNTs and/or MWNTs.

5. The composite according to any one of claims 1 to 4, wherein the composite includes a metal and/or metal oxide layer.

6. The composite of any one of claims 1 to 5, wherein the exposed nanotube tips are coated.

7. The composite according to claim 6, wherein the coating is a biodegradable polymer, a metal and/or metal oxide layer and/or an electrically conducting film.

8. The composite of claim 7, wherein the electrically conducting film is selected from the group consisting of one or more of polyethylene, polyethylene dioxythiophene (PEDOT), soluble polypyrroles, polythiophenes, and polyanilines.

9. The composite according to claim 7 or 8, wherein the coating includes additives.

10. The composite according to claim 9, wherein the additives are selected from the group consisting of one or more biomolecules, radio-isotopes, electrically conducting materials, nanotubes, metal networks and/or a combination thereof.

11. The composite according to claim 10, wherein the nanotubes additives are selected from carbon nanotubes, metal oxide nanotubes such as titanium dioxide nanotubes, metal nanorods and peptidyl nanotubes.

12. The composite of claim 10, wherein the metal networks are metal salts of Au and/or Pt.

13. The composite of any one of claims 1 to 12, wherein the substrate is a polymeric material, an ionic material, and/or a biomolecule.

14. The composite of claim 13, wherein the polymeric material is an electronic conductor selected from one or more of the group consisting of polyethylene, polyethylenedioxythiophene (PEDOT), soluble polypyrroles, polythiophenes and polyanilines.

15. The composite of claim 13, wherein the polymeric material is selected from one or more of the group consisting of acrylates, acrylic acid, polyacrylic esters, polyacrylamides, polyacrylonitriles, chlorinated polymers, fluorinated polymers, styrenic polymers, polyurethanes, natural rubber, synthetic rubber polymers, vinylchloride-acrylate polymers, copolymers thereof and combinations thereof.

16. The composite of claim 15, wherein the polymeric material is selected from one or more of the group consisting of acrylate polymers such as poly(methyl methacrylate), poly(vinyl acetate-acrylate) and poly(vinyl acetate-ethylene); acrylic acid polymers such as poly(acrylic acid), poly(vinyl acetate), polyvinylpropionate, polyacrylic esters and polyacrylamides, polyacrylonitriles; chlorinated polymers such as poly(vinyl chloride), poly(vinylidene chloride), poly(vinyl chloride-ethylene), poly(vinyl chloride-propylene) and vinylchloride-acrylate polymers;
fluorinated polymers such as polytetrafluoroethylene, poly(vinyl fluoride), poly(vinylidene fluoride), poly(vinyl fluoride-ethylene) and poly(vinyl fluoride-propylene); styrenic polymers such as polystyrene, poly(styrene-co-butadiene), styrene-acrylate copolymers and poly(styrene-β-isobutylene-β-styrene (SIBS);
polyurethanes; natural rubber, synthetic rubber polymers such as silicone rubber, Silastic™, copolymers thereof and combinations thereof.

17. The composite of claim 13, wherein ionic material is an ionic liquid and/or an ionic gel.

18. The composite of any one of claims 10 and/or 13, wherein the biomolecule is selected from one or more of the group consisting of biological electrolytes, nucleic acids, poly amino acids, proteins, enzymes, polysaccharides, lipids, hormones, nerve growth factors, antibacterial molecules, cell inhibitory molecules, stem-cells and/or stem-like cells.

19. The composite of claim 18, wherein the biological polyelectrolyte is selected from one or more of the group consisting of hyaluronic acid (HA), chitosan, heparin, chondroitin sulphate, polyglycolic acid (PGA), polylactic acid (PLA), polyamides, poly-2-hydroxy-butyrate (PHB), polycaprolactone (PCL), poly(lactic-co-glycolic) acid (PLGA), protamine sulfate, polyallylamine, polydiallyldimethylammonium, polyethyleneimne, eudragit, gelatin, spermidine, albumin, poyacrylic acid, sodium alginate, polystyrene sulfonate, carrageenin, carboxymethylcellulose.

20. The composite of claim 18, wherein said biomolecule includes one or more monomers and/or one or more oxidants wherein the substrate is rendered conductive by electrochemical or chemical oxidation when one or more monomers are present and/or by vapour phase polymerisation when one or more oxidants are included with the biomolecule.

21. The composite of any one of claims 1 to 20, further comprising additives.

22. The composite of claim 21, wherein additives are selected from the group consisting of one or more biomolecules, radio-isotopes, electrically conducting materials, nanotubes, carbon nanotubes, metal oxide nanotubes such as titanium dioxide nanotubes, metal nanorods and peptidyl nanotubes, metal networks and/or a combination thereof.

23. The composite according to any one of claims 1 to 22, wherein the electrical conductivity of the composite is in the range from 0.1 to 10 s cm⁻¹.

24. A process for preparing a nanostructured composite which comprises the steps of:
i) providing a nanotube layer;
ii) integrating a substrate, optionally comprising a biomolecule, to the nanotube layer produced in step i); and
iii) forming nanotube/substrate composite structure.

25. A process for preparing a nanostructured composite which comprises the steps of:
i) providing a nanotube layer;
ii) providing a dispersion comprising dispersing media, and substrate optionally comprising a biomolecule; and
iii) casting the dispersion onto the nanotube layer, and
iv) forming nanotube/substrate composite structure.

26. The process of claim 25, wherein the concentration of the substrate in the dispersing media is in the range of 1 to 75% (w/v), 5 to 50% (w/v) or 15 to 25% (w/v).

27. The process of any one of claim 25 or 26, wherein the dispersing media is a solvent selected from the group consisting of water, toluene, N-methyl pyrrolidine (NMP), dimethyl propylene urea (DMPU) and tetrahydropuran (THF).

28. The process of any one of claims 25 to 27, wherein the dispersing media includes additives.

29. The process of claim 28, wherein the additive comprises nanotubes dissolved in the dispersing media, wherein the concentration of nanotubes in the dispersing media is in the range of 0.001 to 5%, 0.01% to 0.05% or 0.1 wt % to 1.0 wt %.

30. The process of any one of claims 24 to 29, wherein the additive is a biomolecule and the amount of biomolecule in the substrate is in the range of 1 to 50 (w/w %).

31. The process of any one of claims 24 to 30, further comprising a pre-integrating step.

32. The process of claim 31, wherein the pre-integrating step comprises deposition of a metal and/or metal oxide layer to the nanotubes.

33. A device composed wholly or partly of the nanostructured composite according to any one of claims 1 to 23.

34. The device of claim 33, wherein the device is an electrode, a bio-electrode, battery, capacitor, biobattery, biocapacitor and/or medical device.

35. The device of claim 33 or 34, wherein the device enables release of agents and/or delivery of electrical charge.
